(19) United States
(12) Patent Application Publication
(10) Pub. No.: US 2012/0294653 A1
(43) Pub. Date: Nov. 22, 2012

(54) RECOVERY DEVICE AND IMAGE FORMATION DEVICE

(75) Inventors: Akihiro GOMI, Fujimi-machi (JP); Kazuhiro NISHIYAMA, Shiojiri (JP); Tsutomu SASAKI, Matsumoto (JP); Naoyuki OKUMURA, Shimosuwa-machi (JP)

(73) Assignee: SEIKO EPSON CORPORATION, Tokyo (JP)

(21) Appl. No.: 13/456,754

(22) Filed: Apr. 26, 2012

(30) Foreign Application Priority Data
May 19, 2011 (JP) 2011-112665

(51) Int. Cl. G03G 15/10

(52) U.S. Cl. 399/249

(57) ABSTRACT

Developer is recovered by a development unit, a first squeeze unit, a second squeeze unit, and a photoreceptor cleaning unit, but the developer recovered by the development unit or the first squeeze unit has a relatively high concentration, and is therefore returned to a stirring tank for reuse. The developer recovered by the second squeeze unit or the photoreceptor cleaning unit has a relatively low concentration, and is therefore accumulated in a buffer tank separate from the stirring tank to prevent the toner concentration in the stirring tank from decreasing.

### CROSS-REFERENCE TO RELATED APPLICATIONS

This application claims priority to Japanese Patent Application No. 2011-112665 filed on May 19, 2011. The entire disclosures of Japanese Patent Application No. 2011-112665 is hereby incorporated herein by reference.

### BACKGROUND

1. Technical Field

The present invention relates to a recovery device for recovering a developer including a toner and a carrier liquid from a latent image support, and to an image formation device that is provided with the recovery device.

2. Background Technology

A liquid development-type image formation device has been used that is configured to obtain a predetermined image by forming an electrostatic latent image on a charged photosensitive drum or other latent image support, forming a toner image by visualizing the electrostatic latent image through use of a developer in which a toner is dispersed in a carrier liquid, and transferring the toner image to paper via an intermediate transfer body. In this image formation device, a recovery device that uses a squeeze roller is used to remove and recover fogging toner or excess developer that includes extra carrier liquid from the toner image formed on the image support drum for the latent image (see Patent Citation 1, for example). In the device described in Patent Citation 1, two squeeze rollers disposed along the rotation direction of the drum-shaped latent image support rotate in a predetermined direction to remove charged fogging toner or excess developer from the photoreceptor and recover the toner or developer in a recovery member. The recovered developer is recovered in a stirring tank for reuse.

Japanese Laid-open Patent Publication No. 2010-185984 (Patent Document 1) is an example of the related art.

### SUMMARY

### Problems to Be Solved by the Invention

In the recovery device described above, a first squeeze roller is disposed on the downstream side in the movement direction of the surface of the latent image support, and a second squeeze roller is disposed on the downstream side of the first squeeze roller, relative to the development position at which the electrostatic latent image is developed by the developer. The first squeeze roller makes contact with the latent image support on which the image developed by the developer is supported, and recovers the developer, and the second squeeze roller makes contact with the latent image support squeezed by the first squeeze roller and recovers the developer. A two-stage squeeze process is thus performed. The concentration of toner in the developer recovered by the second squeeze roller is therefore lower than the concentration of toner in the developer recovered by the first squeeze roller. Consequently, as the developer recovered by the second squeeze roller accumulates in the stirring tank, the concentration of toner in the stirring tank decreases significantly.

An advantage of the several embodiments of the invention is to provide a recovery device capable of effectively utilizing recovered developer and preventing the concentration of toner (“toner concentration” hereinafter) in the developer from decreasing, and to provide an image formation device that is provided with the recovery device.

### Means Used to Solve the Above-Mentioned Problems

A first aspect of the invention is a recovery device characterized in including: a first squeeze unit having a first squeeze roller for recovering a developer by making contact with a latent image support on which an image developed by a developer including a toner and a carrier liquid is supported, and a first accumulating part for accumulating the developer recovered by the first squeeze roller; a second squeeze unit having a second squeeze roller for recovering the developer by making contact with the latent image support squeezed by the first squeeze roller, and a second accumulating part for accumulating the developer recovered by the second squeeze roller; a concentration adjustment tank to which the developer accumulated in the first accumulating part is conveyed, the concentration adjustment tank storing the conveyed developer and adjusting the toner concentration of the stored developer; and a storage tank to which the developer accumulated in the second accumulating part is conveyed, the storage tank storing the conveyed developer.

A second aspect of the invention is an image formation device including: a latent image support on which a latent image is formed; a development unit having a development roller for developing the latent image formed on the latent image support by a developer which includes a toner and a carrier liquid; a first squeeze unit having a first squeeze roller for recovering a developer by making contact with the latent image support developed by the development roller, and a first accumulating part for accumulating the developer recovered by the first squeeze roller; a second squeeze unit having a second squeeze roller for recovering the developer by making contact with the latent image support squeezed by the first squeeze roller, and a second accumulating part for accumulating the developer recovered by the second squeeze roller; a concentration adjustment tank to which the developer accumulated in the first accumulating part is conveyed, the concentration adjustment tank storing the conveyed developer and adjusting the toner concentration of the stored developer; and a storage tank to which the developer accumulated in the second accumulating part is conveyed, the storage tank storing the conveyed developer.

In the invention (recovery device and image formation device) thus configured, the developer recovered by the first squeeze roller is stored in the concentration adjustment tank after passing through the first accumulating part, and the toner concentration is adjusted in the concentration adjustment tank. The developer, the concentration of which has been adjusted in this manner, can thereby be reused. Meanwhile, the developer recovered by the second squeeze roller is stored in a storage tank separate from the concentration adjustment tank after passing through the second accumulating part. The toner concentration in the concentration adjustment tank is therefore effectively prevented from being reduced by the developer that is recovered by the second squeeze roller.

A configuration can also be adopted in which the development unit is provided with a development roller cleaning member for recovering the developer by making contact with the development roller, and the concentration adjustment tank stores the developer recovered by the development roller cleaning member.

A configuration can also be adopted in which a first duct is provided through which the developer recovered by the cleaning member flows to the concentration adjustment tank, and a second duct is provided through which the developer recovered by the first squeeze roller flows into the first duct, the second duct being communicated with the first duct.

A configuration can also be adopted in which a transfer unit is provided for transferring the image developed on the latent image support to a transfer medium by making contact with the latent image support squeezed by the second squeeze roller; and a cleaning unit is provided having a cleaning member for making contact with and cleaning the latent image support from which the image is transferred to the transfer member by the transfer unit, and recovering the developer; wherein the storage tank stores the developer recovered by the cleaning member of the cleaning unit.

### BRIEF DESCRIPTION OF THE DRAWINGS

Referring now to the attached drawings which form a part of this original disclosure:

FIG. 1 is a view showing an image formation device equipped with an embodiment of the recovery device of the invention;

FIG. 2 is a schematic view showing the path of feeding and recovery of the developer in the device shown in FIG. 1;

FIG. 3 is a schematic view showing the path of feeding and recovery of the developer in the development unit;

FIG. 4 is a view showing another embodiment of the image formation device of the invention;

FIG. 5 is a view showing the relationship between the toner concentration of the developer recovered by each recovery member and the image coverage; and

FIG. 6 is a view showing the relationship between reductions in toner concentration in the stirring tank and the image coverage.

### DETAILED DESCRIPTION OF EXEMPLARY EMBODIMENTS

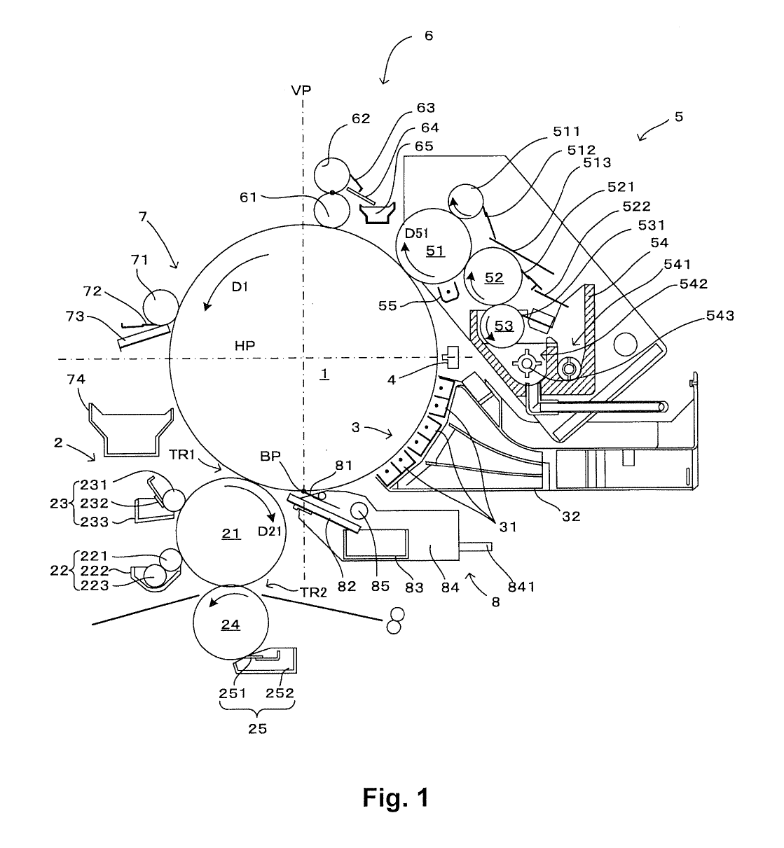

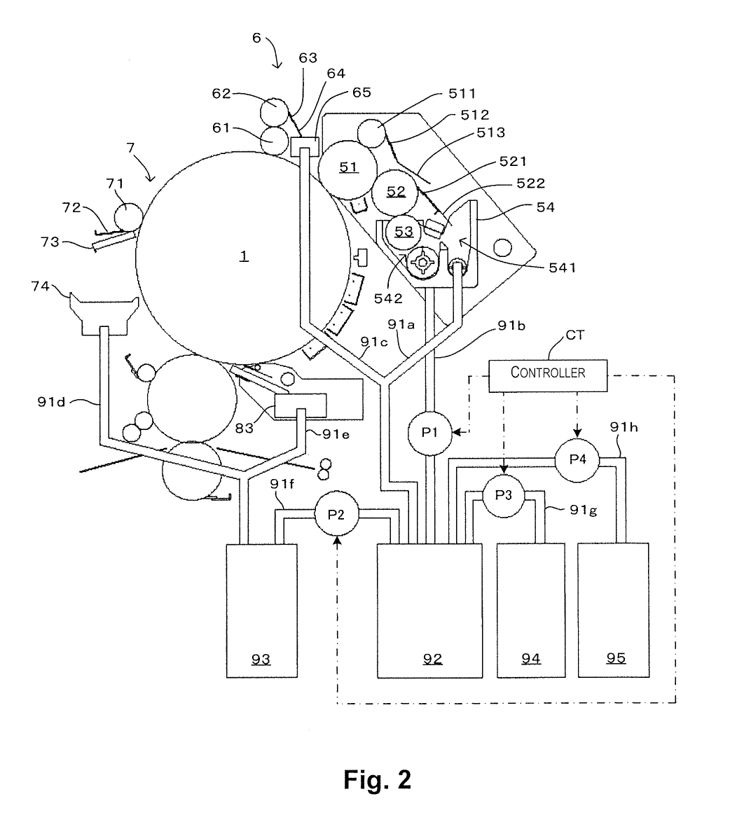

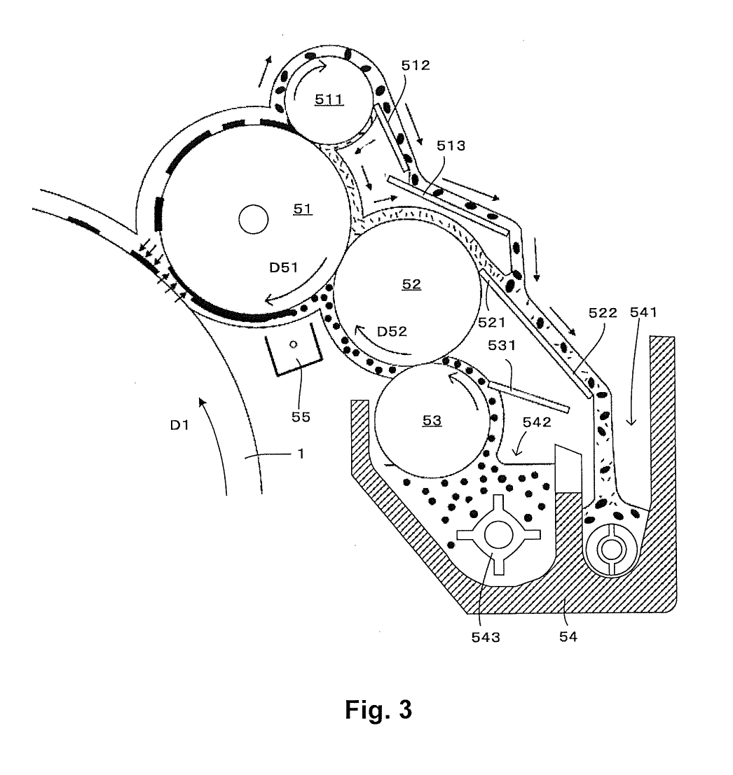

FIG. 1 is a view showing an image formation device equipped with an embodiment of the recovery device of the invention. FIG. 2 is a schematic view showing the path of feeding and recovery of the developer in the device shown in FIG. 1. FIG. 3 is a schematic view showing the path of feeding and recovery of the developer in the development unit. At the bottom in the direction perpendicular to an imaginary horizontal plane HP which passes through the center of rotation of a photosensitive drum 1, the image formation device has a so-called lower transfer structure in which an image supported on the photosensitive drum 1 is transferred to a blanket roller 21 of a primary transfer unit 2, and the image transferred to the blanket roller 21 is then transferred to a transfer paper (transfer medium). The image formation device shown in FIG. 1 is designed to form a printed article by forming a monochrome toner image as described hereinafter and transferring the image to the transfer paper, and a color printing system can also be formed by assembling a plurality of the abovementioned device, e.g., four devices. It is apparent that the device shown in FIG. 1 functions alone as a monochrome image formation device.

In the image formation device, the photosensitive drum 1 has on the surface thereof a photosensitive layer composed of amorphous silicon or another photoreceptor material. The photosensitive drum 1 is disposed so that a rotation shaft thereof is parallel or substantially parallel to the primary scanning direction (the direction perpendicular to the paper surface in FIG. 1), and the photosensitive drum 1 is rotated at a predetermined speed in the direction indicated by the arrow D1 in FIG. 1.

On the periphery of the photosensitive drum 1, a charging unit 3 for charging the surface of the photosensitive drum 1 to a predetermined potential, an exposure unit 4 for forming an electrostatic latent image by exposing the surface of the photosensitive drum 1 to light in accordance with an image signal, a development unit 5 for developing the electrostatic latent image with a developer to form a toner image, a first squeeze unit 6, a second squeeze unit 7, the blanket roller 21 of the primary transfer unit 2, and a photoreceptor cleaning unit 8 for cleaning the surface of the photosensitive drum 1 after primary transfer are arranged in this order in the rotation direction D1 (counterclockwise direction in FIG. 1) of the photosensitive drum 1.

The charging unit 3 has six chargers 31 and a charger airflow duct 32, and in FIG. 1, is disposed to the right of an imaginary vertical plane VP through the center of rotation of the photosensitive drum 1, and below in the vertical direction in relation to the imaginary horizontal plane HP through the center of rotation of the photosensitive drum 1. The chargers 31 do not touch the surface of the photosensitive drum 1, and six chargers are aligned in the rotation direction D1 of the photosensitive drum 1. For example, corona chargers in the past can be used as the chargers 31. In the case that scorotron chargers are used as the corona chargers, a wire current is sent through the charge wires of the scorotron chargers, and a direct-current (DC) grid charging bias is applied to the grids. The photosensitive drum 1 is thus charged by the corona discharge of the chargers 31, and the surface potential of the photosensitive drum 1 is thereby set to a uniform value. The charger airflow duct 32 has an outside-air inlet channel (not shown) for introducing outside air to the chargers 31, and an exhaust channel (not shown) for discharging the atmosphere generated by the electrical discharge of the chargers 31, and the charger airflow duct 32 performs atmospheric management for ventilating the atmosphere in which charging is performed.

The exposure unit 4 is disposed on the imaginary horizontal plane HP to the right of the imaginary vertical plane VP in FIG. 1, and forms an electrostatic latent image corresponding to an image signal by exposing the surface of the photosensitive drum 1 with a beam of light in accordance with the image signal presented from an external device. In the present embodiment, a line head in which luminescent elements are arranged in the primary scanning direction (direction perpendicular to the paper surface in FIG. 1) is used as the exposure unit 4, but an exposure unit in which a beam of light from a semiconductor laser is scanned in the primary scanning direction by a polygon mirror can also be used. The exposure unit 4 is disposed on the imaginary horizontal plane HP in the present embodiment, but the positioning of the exposure unit 4 is not thus limited, and the exposure unit 4 can be disposed higher or lower in the vertical direction than the imaginary horizontal plane HP.

The developer is applied from the development unit 5 to the electrostatic latent image formed as described above, and the electrostatic latent image is developed by the toner. The developer used in the present embodiment is one in which colored resin particles as toner are dispersed at a weight ratio of about 25% in a carrier liquid primarily composed of an insulative liquid, and the toner is charged so as to be able to undergo electrophoresis in an electric field. The developer concentration is not limited to the 25% described above, and can be 10 to 30%. Isopar (registered trademark of Exxon Mobil Corporation), silicone oil, normal paraffin oil, or the like, for example, is used as the carrier liquid. The electrical resistance thereof is preferably 10¹⁰ Ω·cm or greater, and more preferably 10¹² Ω·cm or greater. The reason for this is that when the resistance of the carrier liquid is low, an excess of current flows in the process by which the toner undergoes electrophoresis, and the electric field necessary for movement can be impossible to maintain. The viscosity of the developer thus configured is dependent upon the dispersant/charge control agent or the resin constituting the toner, but a developer having a viscosity of 50 to 500 [mPa·s] can be used, and a developer having a viscosity of 400 [mPa·s] is used in the present embodiment.

The development unit 5 of the image formation device is disposed to the right of the imaginary vertical plane VP in FIG. 1 and above the charging unit 3 in the vertical direction, and is primarily composed of a development roller 51, an intermediate application roller 52, an anilox roller 53, a developer container 54 for storing the developer, and a toner compression corona generator 55 for applying charging and compression action to the developer. Among these main components, the development roller 51 is a cylindrical member in which a polyurethane rubber, silicone rubber, NBR, or other elastic layer is provided on the external peripheral portion of a metal core made of iron or other metal, and in which a PFA tube or resin coating is applied to the development roller surface layer of the external peripheral portion. The development roller 51 is connected to a development motor (not shown) and rotated in the clockwise direction D51 in FIG. 1 so as to rotate with the photosensitive drum 1. The development roller 51 is also electrically connected to a development bias generator not shown in the drawing, and a development bias is applied that corresponds to a control signal from a controller CT (FIG. 2) for controlling the device as a whole at the appropriate timing.

An intermediate application roller 52 and an anilox roller 53 for supplying the developer to the development roller 51 are also provided, and the developer is supplied from the anilox roller 53 to the development roller 51 via the intermediate application roller 52. Of these rollers, the intermediate application roller 52 is one in which an elastic layer is provided on the external peripheral portion of a metal core, the same as in the development roller 51, but the anilox roller 53 is a roller in which a pattern of depressions is formed by helical grooves or the like finely and uniformly engraved in the surface thereof so as to facilitate supporting the developer. The anilox roller 53 used can also be one in which a urethane, NBR, or other rubber layer is wrapped around a metal core and covered with a PFA tube, the same as the development roller 51 or the intermediate application roller 52. The intermediate application roller 52 and the anilox roller 53 are connected to the abovementioned development motor and rotated clockwise and counterclockwise, respectively, as shown in FIG. 1. Consequently, the intermediate application roller 52 rotates counter to the development roller 51, and the anilox roller 53 rotates with the intermediate application roller 52. In the present embodiment, since the developer is fed from the developer container 54 to the development roller 51 by a so-called three-roller configuration, the developer passes through a plurality of nips and can thereby be adequately worked, and a uniform film of the developer can be formed on the development roller 51. This configuration is not limiting, however, and a configuration (two-roller configuration) can be adopted in which the developer is applied directly from the anilox roller 53 to the development roller 51.

The development roller 51 is contacted by a cleaning roller 511, and the cleaning roller 511 is contacted by a roller cleaning blade 512, whereby cleaning of the development roller 51 is performed. Specifically, the cleaning roller 511 rotates clockwise in FIG. 1 while making contact with the surface of the development roller 51 at a point downstream in the development roller rotation direction D51 from the development position at which a development nip is formed by contact of the surface of the development roller 51 with the photosensitive drum 1. Consequently, the cleaning roller 511 rotates counter to the development roller 51 and removes the developer that remains on the development roller 51 without contributing to development. The roller cleaning blade 512 makes contact with the surface of the cleaning roller 511 and scrapes off the developer. A cleaning blade 521 makes contact with the intermediate application roller 52 and scrapes the developer that remains on the intermediate application roller 52 without contributing to development from off the surface of the intermediate application roller 52. The developer scraped off by the cleaning blades 512, 521 is guided into and recovered in a recovery member 541 of the developer container 54 by inclined members 513, 522, as shown in FIG. 3. A tube 91a extending downward in the vertical direction from the bottom of the recovery member 541 is connected to a stirring tank 92, as shown in FIG. 2. The developer recovered in the recovery member 541 in the manner described above is therefore sent into the stirring tank 92 via the tube 91a by gravity.

A restricting member 531 makes contact with the anilox roller 53. A metal member or an elastic member formed by covering a surface with an elastic member can be used as the restricting member 531, but the restricting member 531 in the present embodiment is composed of a rubber portion made of urethane rubber or the like which makes contact with the surface of the anilox roller 53, and a metal plate or other plate for supporting the rubber portion. The restricting member 531 has the function of restricting and adjusting the film thickness or amount of the developer conveyed by the anilox roller 53 and adjusting the amount of developer that is fed to the development roller 51. The developer scraped off by the restricting member 531 is returned to a storage part 542 of the developer container 54. A stirring part 543 is disposed in the storage part 542 and rotated by a motor not shown in the drawing, and the developer in the storage part 542 is thereby stirred. The top end of a tube 91b is connected to the bottom of the storage part 542. The tube 91b extends downward in the vertical direction, and the bottom end of the tube 91b is connected to the stirring tank 92. The developer in the stirring tank 92 can thus be fed to the storage part 542 by the tube 91b.

In the manner described above, the development roller 51 to which the developer is fed rotates so as to move in the opposite direction relative to the surface of the intermediate application roller 52, and rotates so as to move in the same direction as the surface of the photosensitive drum 1. In order to form a toner image, the development roller 51 must rotate with the photosensitive drum 1 so that the surface of the development roller 51 moves in the same direction as the surface of the photosensitive drum 1, but the surface of the development roller 51 can still move in the opposite direction or in the same direction as that of the intermediate application roller 52.

The toner compression corona generator 55 is disposed in the rotation direction of the development roller 51. More specifically, the toner compression corona generator 55 is disposed upstream in the development roller rotation direction D51 from the development position. The toner compression corona generator 55 is an electric field application unit for increasing the bias of the surface of the development roller 51, and an electric field is applied at the position where the toner of the developer conveyed by the development roller 51 is closest to the toner compression corona generator 55, and the toner is charged and compressed. This charging and compression of the toner can also be accomplished by using a compaction roller for charging in contact with the toner, instead of by corona discharge by electric field application.

The development unit 5 configured as described above is connected to a development unit advance/retreat mechanism not shown in the drawing, and the development unit 5 can move back and forth between a development position (indicated by solid lines in FIG. 1) for developing the latent image on the photosensitive drum 1 and a retreat position (not shown) at a distance from the photosensitive drum 1, in response to a control command transmitted from the controller CT to the development unit advance/retreat mechanism. Consequently, once the development unit 5 has moved into the retreat position, additional feeding of developer to the photosensitive drum 1 is stopped.

The first squeeze unit 6 is disposed downstream in the rotation direction D1 of the photosensitive drum 1 from the development position at which the electrostatic latent image is developed by the developer, and the second squeeze unit 7 is disposed downstream from the first squeeze unit 6. In this embodiment, the first squeeze unit 6 and the second squeeze unit 7 correspond to the “recovery device” of the invention, and each of these units is configured as described below.

The first squeeze unit 6 has a squeeze roller 61, a cleaning roller 62, a cleaning blade 63, a developer receiving member 64, and a recovery member 65. Of these constituent elements, the squeeze roller 61 is disposed to the right of the imaginary vertical plane VP in FIG. 1 and above in the vertical direction in relation to the imaginary horizontal plane HP. The squeeze roller 61 is supported by a support plate not shown in the drawing, together with the cleaning roller 62, the cleaning blade 63, and the developer receiving member 64. The support plate is pivotally supported about a rotation shaft at a position separated from the photosensitive drum 1, and the squeeze roller 61, the cleaning roller 62, the cleaning blade 63, and the developer receiving member 64 can be moved integrally with each other about the rotation shaft. The support plate is connected to a cylinder, motor, or other drive unit (not shown), and the drive unit activates in response to a rotation command from the controller CT. The support plate thereby rotates about the rotation shaft and causes the peripheral surface of the squeeze roller 61 to make contact with or separate from the photosensitive drum 1.

The support plate is thus rotated in a predetermined direction by the drive unit, and the squeeze roller 61 makes contact with the photosensitive drum 1 as shown in FIGS. 1 and 2. In contact with the photosensitive drum 1 at a first squeeze position in this manner, the squeeze roller 61 is rotated in the same direction as the rotation direction of the photosensitive drum 1, i.e., the squeeze roller 61 is rotated with the photosensitive drum 1, by a motor not shown in the drawing. The squeeze roller 61 thereby squeezes the image developed by the development unit 5 to recover the excess developer.

The cleaning roller 62 in contact with the peripheral surface of the squeeze roller 61 is disposed above the squeeze roller 61 in the vertical direction. The cleaning roller 62 in contact with the squeeze roller 61 is rotated by receiving the rotational drive power of the motor. In this embodiment, the rotational drive power generated by the motor is presented to the rollers 61, 62 through a drive power transmission mechanism (not shown), and the cleaning roller 62 rotates faster than the peripheral speed of the squeeze roller 61 and in the opposite direction from the rotation direction of the squeeze roller 61; i.e., the cleaning roller 62 rotates counter to the squeeze roller 61. In order to increase the squeeze efficiency in the present embodiment, a squeeze bias generator (not shown) is electrically connected to the rollers 61, 62, and a squeeze bias is applied to the squeeze rollers 61, 62 at the appropriate timing.

The cleaning blade 63 is disposed above an imaginary horizontal plane passing through the center of rotation of the squeeze roller 61, and to the right of an imaginary vertical plane passing through the center of rotation of the squeeze roller 61, and the cleaning blade 63 makes contact with and cleans the cleaning roller 62 at a position of movement from top to bottom in the vertical direction. The developer recovered from the peripheral surface of the cleaning roller 62 moves by gravity along the top surface of the cleaning blade 63 in the vertical direction thereof to the end of the cleaning blade 63 opposing the cleaning roller and falls downward in the vertical direction from the end of the cleaning blade 63.

The developer receiving member 64 is provided below the cleaning blade 63 in the vertical direction as shown in FIG. 1, in order to reliably recover the falling developer while preventing the developer from scattering into the area around the photosensitive drum 1 or the first squeeze unit 6. The end portion of the developer receiving member 64 on the side of the cleaning roller is higher in the vertical direction than the end portion on the side opposing the cleaning roller, and the developer receiving member 64 inclines downward in the vertical direction as the developer receiving member 64 progresses away from the cleaning roller 62, and extends to a point vertically above the recovery member 65. The developer scraped from the cleaning roller 62 by the cleaning blade 63 therefore flows along the top surface of the cleaning blade 63 and drops off from the end portion of the cleaning blade 63 opposing the cleaning roller, whereupon the developer is received by the end portion of the developer receiving member 64 on the side of the squeeze roller to flow along the top surface of the developer receiving member 64, i.e., the inclined surface, as recovered liquid, and drips onto the recovery member 65. The developer recovered by the squeeze roller 61 of the first squeeze unit 6 is thus accumulated in the recovery member 65, and the recovery member 65 in the present embodiment functions as the “first accumulating part” of the invention.

As shown in FIG. 2, a tube 91c extends downward in the vertical direction from the bottom of the recovery member 65 and merges with a middle portion of the tube 91a, and is connected to the stirring tank 92. The developer recovered in the recovery member 65 in the manner described above is therefore sent by gravity into the stirring tank 92 via the tubes 91c, 91a.

The second squeeze unit 7 has a squeeze roller 71, a cleaning blade 72, a developer receiving member 73, and a recovery member 74, and is disposed to the left of the imaginary vertical plane VP in FIG. 1. Among the constituent elements of the second squeeze unit 7, the squeeze roller 71, the cleaning blade 72, and the developer receiving member 73 are disposed above the imaginary horizontal plane HP in the vertical direction, and the recovery member 74 is fixedly disposed below the imaginary horizontal plane HP in the vertical direction. In this embodiment, the squeeze roller 71, the cleaning blade 72, and the developer receiving member 73 are integrally supported by a support plate (not shown). The support plate is pivotally supported about a rotation shaft at a position separated from the photosensitive drum 1, and the squeeze roller 71, the cleaning roller 72, and the developer receiving member 73 can be moved integrally with each other about the rotation shaft. The support plate is connected to a cylinder, motor, or other drive unit (not shown), and the drive unit activates in response to a rotation command from the controller CT. The support plate thereby rotates about the rotation shaft and causes the peripheral surface of the squeeze roller 71 to make contact with or separate from the photosensitive drum 1.

The support plate is thus rotated in a predetermined direction by the drive unit, and the squeeze roller 71 makes contact with the photosensitive drum 1 as shown in FIGS. 1 and 2 and rotates in the same direction as the rotation direction of the photosensitive drum 1, i.e., the squeeze roller 71 rotates with the photosensitive drum 1. The excess developer is thereby recovered. In order to increase the squeeze efficiency in the present embodiment, a second squeeze bias generator (not shown) is electrically connected to the squeeze roller 71, and a second squeeze bias is applied at the appropriate timing.

The cleaning blade 72 cleans in contact with the squeeze roller 71. The developer recovered from the peripheral surface of the squeeze roller 71 in this manner falls downward in the vertical direction due to gravity. The developer receiving member 73 is provided below the cleaning blade 72 in the vertical direction, in order to reliably recover the falling developer while preventing the developer from scattering into the area around the photosensitive drum 1 or the second squeeze unit 7. The developer scraped from the squeeze roller 71 by the cleaning blade 72 therefore flows along the bottom surface of the cleaning blade 72, and is received by the developer receiving member 73.

The end portion of the developer receiving member 73 on the side of the squeeze roller (e.g., the upper right side in FIG. 1) is higher in the vertical direction than the end portion on the side opposing the squeeze roller, and the developer receiving member 73 inclines downward in the vertical direction as the developer receiving member 73 progresses away from the squeeze roller 71, and extends to a point vertically above the recovery member 74. The developer therefore drops off from the squeeze roller 71, whereupon the developer is received by the end portion of the developer receiving member 73 on the side of the squeeze roller. The developer thus scraped off is guided as recovered liquid in the direction away from the photosensitive drum 1 by the developer receiving member 73 and is recovered in the recovery member 74 disposed below the developer receiving member 73 in the vertical direction. The developer recovered by the squeeze roller 71 of the second squeeze unit 7 is thus accumulated in the recovery member 74, and the recovery member 74 in the present embodiment functions as the “second accumulating part” of the invention.

A tube 91d extends downward in the vertical direction from the bottom of the recovery member 74 and connects to a buffer tank 93, as shown in FIG. 2. The developer recovered by the recovery member 74 in the manner described above is therefore sent by gravity into the buffer tank 93 via the tube 91d.

A toner image corresponding to an image signal presented from outside the device is formed on the photosensitive drum 1, the photosensitive drum 1 having passed the first and second squeeze units 6, 7, and the toner image is transferred to the blanket roller 21 at a primary transfer position TR1. The transfer unit 2 that includes the blanket roller 21 is disposed to the left of the imaginary vertical plane VP in FIG. 1 and below the imaginary horizontal plane HP. This transfer unit 2 has the blanket roller 21; a carrier application mechanism 22 for applying a carrier liquid to the blanket roller 21; a cleaning unit 23 for the blanket roller 21; a secondary transfer roller 24; and a cleaning unit 25 for the secondary transfer roller 24.

The surface of the blanket roller 21 makes contact with the surface of the photosensitive drum 1 and forms a primary transfer nip at a point upstream in the rotation direction D1 of the photosensitive drum 1 from the bottom point of the photosensitive drum 1 in the vertical direction, i.e., a position BP of intersection with the imaginary vertical plane VP at the bottom in the vertical direction of the photosensitive drum 1. The position at which the primary transfer nip is formed is the primary transfer position TR1. The blanket roller 21 is connected to a motor not shown in the drawing, and is thereby rotated with the photosensitive drum 1 in the clockwise direction D21 in FIG. 1. The toner image supported on the photosensitive drum 1 thus undergoes primary transfer to the blanket roller 21 at the primary transfer position TR1.

The secondary transfer roller 24 rotates with the blanket roller 21 while in contact therewith and forms a secondary transfer nip at a point downstream from the primary transfer position TR1 in the rotation direction D21 of the blanket roller 21. The position at which the secondary transfer nip is formed is a secondary transfer position TR2. Consequently, the transfer paper (recording medium) is fed to the secondary transfer position TR2 by a conveyance unit not shown in the drawing, and passes through the secondary transfer nip, and the toner image thereby transferred to the blanket roller 21 undergoes secondary transfer to the transfer paper. An image formed using the developer described above is thus printed on the transfer paper.

The carrier application mechanism 22 is disposed downstream from the secondary transfer position TR2 in the rotation direction D21 of the blanket roller 21, and applies the carrier liquid to the surface of the blanket roller 21 after secondary transfer. In order to perform this application of the carrier liquid, the carrier application mechanism 22 has a carrier application roller 221 which rotates with the blanket roller 21; a carrier storage member 222 for storing the carrier liquid; and a carrier uptake roller 223 for drawing up the carrier liquid from the carrier storage member 222 and feeding the carrier liquid to the carrier application roller 221.

The cleaning unit 23 is disposed downstream from the carrier application mechanism 22 and upstream from the primary transfer position TR1 in the rotation direction D21 of the blanket roller 21, and the cleaning unit 23 cleans the surface of the blanket roller 21 immediately before primary transfer. In order to perform this cleaning, the cleaning unit 23 has a cleaning roller 231 which rotates counter to the blanket roller 21; a cleaning blade 232 which makes contact with the cleaning roller and cleans the cleaning roller 231; and a recovery member 233 for recovering the toner and carrier liquid scraped off by the cleaning blade 232.

The cleaning unit 25 is disposed upstream from the secondary transfer position TR2 in the rotation direction of the secondary transfer roller 24, and the cleaning unit 25 cleans the surface of the secondary transfer roller 24 immediately before secondary transfer. In order to perform this cleaning, the cleaning unit 25 has a cleaning blade 251 which makes contact with the secondary transfer roller 24 and cleans the secondary transfer roller 24, and a recovery member 252 for recovering the toner and carrier liquid scraped off by the cleaning blade 251.

The photoreceptor cleaning unit 8 is disposed downstream from the primary transfer position TR1 and upstream from the charging position in the rotation direction D1 of the photosensitive drum 1. The photoreceptor cleaning unit 8 has a cleaning blade 81; a developer receiving member 82 for receiving the developer that drops from the bottom point BP of the photosensitive drum 1; a recovery member 83 for recovering the developer received by the developer receiving member; and a support member 84 for integrally supporting the cleaning blade 81, the developer receiving member 82, and the recovery member 83. The support member 84 freely rotates about the center of rotation of a rotation shaft 85.

A spring member (not shown) connected to the support member 84 urges the support member 84 in the counterclockwise direction in FIG. 1 so that the cleaning blade 81 moves away from the photosensitive drum 1. An engaging part 841 protrudes from the end of the support member 84 on the opposite side thereof from the photosensitive drum (the right side in FIG. 1), and when a movable piece not shown in the drawing pushes down the engaging part 841 with a stress greater than the abovementioned urging force, the support member 84 is rotated in the clockwise direction in FIG. 1, whereby the cleaning blade 81 is moved toward the photosensitive drum and the distal end of the cleaning blade 81 makes contact with the bottom point BP of the photosensitive drum 1. The developer remaining on the photosensitive drum 1 is thereby cleaned off. The developer scraped off by the cleaning blade 81 in this manner is received by the developer receiving member 82 disposed below the bottom point BP of the photosensitive drum 1 in the vertical direction, and the developer flows along the inclined surface of the developer receiving member 82 into the recovery member 83 and is stored.

As shown in FIG. 2, a tube 91e extends downward in the vertical direction from the bottom of the recovery member 83 and merges with a middle portion of the tube 91d, and is connected to the buffer tank 93. The developer recovered in the recovery member 83 in the manner described above is therefore sent by gravity into the buffer tank 93 via the tubes 91e, 91d.

The developer is recovered by the development unit 5, the first squeeze unit 6, the second squeeze unit 7, and the photoreceptor cleaning unit 8 in the present embodiment in the manner described above, but the developer recovered by the development unit 5 or the first squeeze unit 6 is returned to the stirring tank 92, and the developer recovered by the second squeeze unit 7 or the photoreceptor cleaning unit 8 is returned to the buffer tank 93. The reason for this is that the toner concentration in the developer recovered by the development unit 5, the first squeeze unit 6, the second squeeze unit 7, and the photoreceptor cleaning unit 8 in this order gradually decreases (a specific example of this phenomenon is given in the description of the example below). In other words, since the toner concentration of the developer recovered by the second squeeze unit 7 or the photoreceptor cleaning unit 8 is lower than that of the developer recovered by the development unit 5 or the first squeeze unit 6, when developer having this relatively low concentration is returned to the stirring tank 92, the toner concentration of the developer accumulated in the stirring tank 92 decreases significantly. The toner concentration in the developer recovered by the second squeeze unit 7 is significantly reduced particularly in the case that an image having high image coverage is formed (a specific example of the relationship between image coverage and the toner concentration of the recovered developer is also given in the description of the example below). In a device in which a pump P1 inserted in the tube 91b is activated in response to a command from the controller CT to pump the developer in the stirring tank 92 into the development unit 5 for reuse, the resultant decrease in toner concentration leads to reduced image quality. In the present embodiment, however, although the first squeeze unit 6 and the second squeeze unit 7 each have the same function and are constituent elements of the “recovery device” of the invention, the developer having a relatively high concentration that is recovered by the first squeeze unit 6 positioned upstream in the rotation direction of the photosensitive drum 1 is returned without modification thereof to the stirring tank 92 for reuse, while the developer having a relatively low concentration that is recovered by the second squeeze unit 7 at a downstream position is accumulated in the buffer tank 93 separate from the stirring tank 92 to prevent the toner concentration thereof from decreasing.

Since the developer accumulated in the buffer tank 93 is of low concentration, as mentioned above, and is similar to the carrier liquid, this developer can be used to adjust the toner concentration or liquid volume of the developer in the stirring tank 92. In the present embodiment, the buffer tank 93 is connected to the stirring tank 92 by a tube 91 f as shown in FIG. 2, and a pump P2 inserted in the tube 91 f is activated in response to a command from the controller CT. The low-concentration developer can thereby be pumped into the stirring tank 92 to adjust the toner concentration or liquid volume in the stirring tank 92. Since the developer having a concentration near to that of the carrier liquid is thus reused, consumption of the carrier liquid can be reduced, and operating cost can be reduced. In the embodiment configured as described above, the stirring tank 92 and the buffer tank 93 can be disposed adjacent to each other, and the duct length for recovering the developer can be reduced. In the case that the amount of developer accumulated in the buffer tank 93 exceeds the tank capacity of the buffer tank 93 as a result of continuous recovery, the excess developer is discarded from a drain (not shown) provided to the buffer tank 93.

In the present embodiment, a carrier tank 96 and a concentrated developer tank 94 for replenishment are also provided to adjust the toner concentration or liquid volume of the developer in the stirring tank 92. The concentrated developer tank 94 for replenishment is a tank for accumulating concentrated developer for replenishment having a high concentration, e.g., 35%, that is higher than the desired concentration of the developer, and the concentrated developer tank 94 for replenishment is connected to the stirring tank 92 by a tube 91g. A pump P3 is provided to the tube 91g, and the pump P3 activates in response to a command from the controller CT and pumps the concentrated developer to the stirring tank 92. The carrier tank 96 is a tank for accumulating carrier liquid for replenishment, and is connected to the stirring tank 92 by a tube 91h. A pump P4 is provided to the tube 91h, and the pump P4 activates in response to a command from the controller CT and pumps the carrier liquid to the stirring tank 92.

In the present embodiment, a recycling system (tube 91f +pump P2) for pumping developer having a concentration near that of the carrier liquid from the tank 93, and a replenishment system (tube 91h+pump P4) for pumping the carrier liquid as such from the tank 95 are provided as systems for reducing the toner concentration in the manner described above, but the controller CT activates the pump P2 of the recycling system with priority, and activates the pump P4 of the replenishment system only when the buffer tank 93 is empty. The frequency with which carrier liquid is pumped from the carrier tank 96 can therefore be minimized, and as a result, consumption of carrier liquid is reduced, and operating cost can be reduced.

In the embodiment described above, the developer recovered from the development roller 51 is made to flow into the stirring tank 92 through the tube 91a, but the tube 91c branches and extends upward in the vertical direction at a middle portion of the tube 91a. Therefore, through the tube 91c, the developer recovered by the first squeeze unit 6 drips into the developer from the development roller 51 that flows through the tube 91a. as a result, the following operational effects are obtained. Specifically, the developer recovered from the development roller 51 has a relatively high concentration (which is extremely high particularly in the case of a low image coverage). Solid components also sometimes coagulate, i.e., toner aggregations form, in the process of development. These factors can cause reduced fluidity in the tube 91a of the developer recovered from the development roller 51. However, since the developer recovered by the first squeeze unit 6 is dripped in the tube 91a in the present embodiment, aggregations and viscous developer in the tube 91a are washed out, and clogging of the tube 91a can therefore be effectively prevented.

In the present embodiment, the stirring tank 92 and the buffer tank 93 thus correspond to the “concentration adjustment tank” and “storage tank,” respectively, of the invention. The photosensitive drum 1 corresponds to the “latent image support” of the invention.

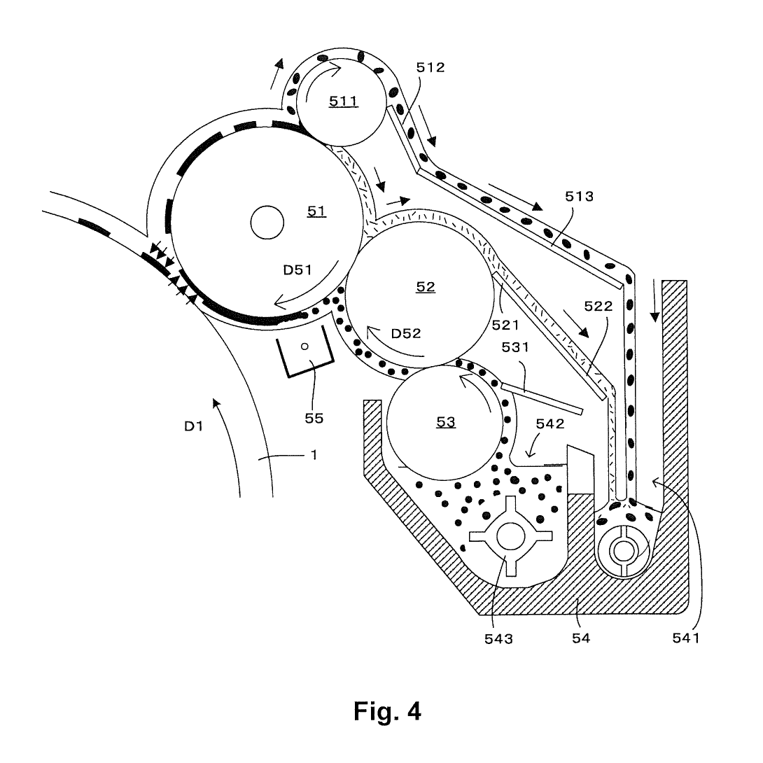

The invention is not limited to the embodiment described above and can be modified in various other ways within the intended scope of the invention. For example, the developer (recovered liquid) scraped off by the roller cleaning blade 512 is conveyed above the recovery member 541 of the developer container 54 by the inclined members 513, 522 in the embodiment described above. However, a configuration can be adopted in which the inclined member 513 is extended to a point above the recovery member 541 of the developer container 54 in the vertical direction, and the developer scraped off by the blade 512 is dropped directly into the recovery member 541 from the inclined member 513, as shown in FIG. 4, for example. In this case, the inclined member 522 guides only the developer (recovered liquid) scraped off by the blade 521 to a point above the recovery member 541 of the developer container 54 in the vertical direction.

In the embodiment described above, a case is described in which the invention is applied to an image formation device having a so-called lower transfer structure. However, the invention can also be applied to an image formation device having a so-called upper transfer structure in which an image supported on the photosensitive drum 1 is transferred at a point in the vertical direction above the imaginary horizontal plane HP that passes through the center of rotation of the photosensitive drum 1.

### EXAMPLES

An example of the invention will next be described, but the invention is, of course, not limited by the following example, and can be implemented with the addition of modifications appropriate to the intended scope thereof as described above and below. Such modifications are all encompassed by the technical scope of the invention.

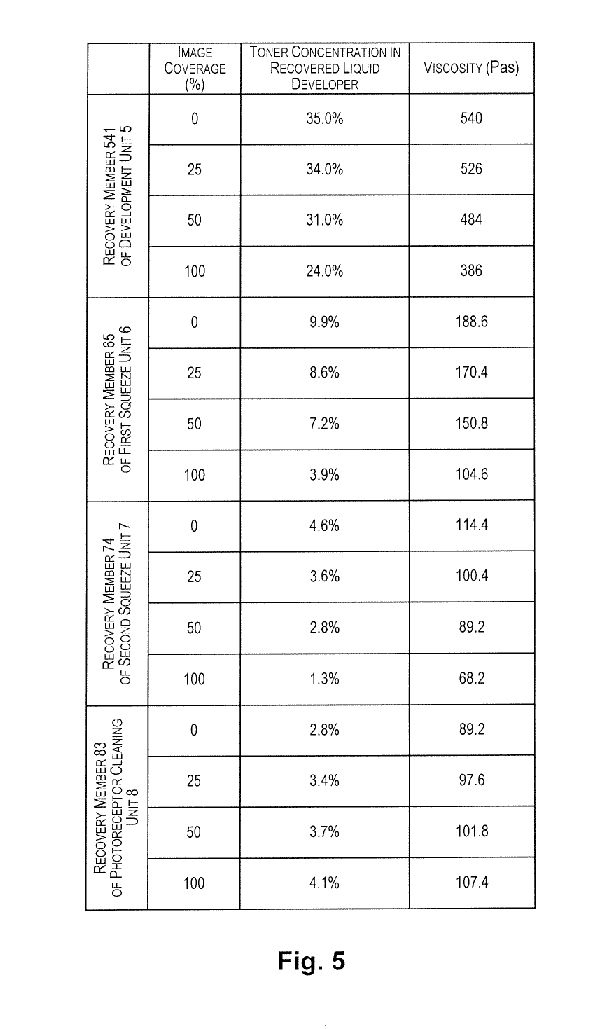

The weight ratio of toner in the developer, i.e., the toner concentration and the viscosity, in the developer recovered by the recovery members 541, 65, 74, 83 of an image formation device configured as shown in FIG. 1 were measured for each image coverage (0, 25, 50, and 100%) of a printed matter, and the measurement results are summarized in FIG. 5.

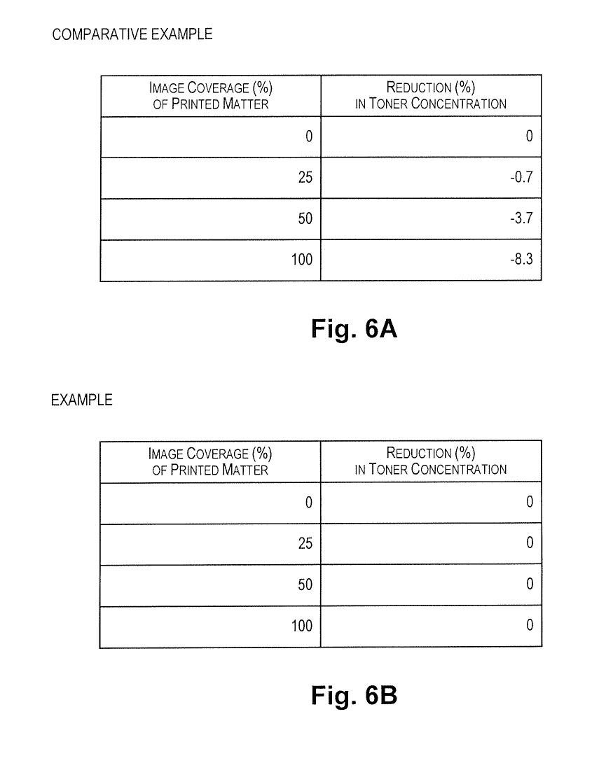

In order to verify that the toner concentration of the developer accumulated in the stirring tank 92 varies according to image coverage, the decrease in concentration after printing 1,000 successive sheets of a printed matter in A3 size was measured for each image coverage (0, 25, 50, and 100%) of the printed matter by the image formation device shown in FIG. 1 and a device (comparative example) in which the buffer tank 93 was omitted from the image formation device configuration shown in FIG. 1 and the developer recovered by the second squeeze unit 7 and the photoreceptor cleaning unit 8 was pumped into the stirring tank 92. These measurement results are summarized in FIG. 6. In FIG. 6, “Printed matter image coverage (50%)→Toner concentration reduction (−3.7%)” means that the toner concentration of the developer accumulated in the stirring tank 92 decreased 3.7% (the initial concentration decreased from 25% to 21.3%) after the operation of printing on the entire area of the transfer paper at an image coverage of 50% (a total printed dot area of 50% of the paper area) was performed for 1,000 sheets of A3 paper.

For the image formation device shown in FIG. 1, the allowable concentration reduction not resulting in reduced image quality was about −1%. Consequently, image quality was reduced in the comparative example when the image coverage was more than about 30%. In the image formation device shown in FIG. 1, however, the toner concentration of the developer accumulated in the stirring tank 92 did not decrease for any image coverage, there was no reduction in image quality, and image formation was continuously stable.

What is claimed is:

1. A recovery device comprising:
a first squeeze unit having a first squeeze roller for recovering a developer by making contact with a latent image support on which an image developed by a developer including a toner and a carrier liquid is supported, and a first accumulating part for accumulating the developer recovered by said first squeeze roller;
a second squeeze unit having a second squeeze roller for recovering the developer by making contact with the latent image support squeezed by the first squeeze roller, and a second accumulating part for accumulating the developer recovered by said second squeeze roller;
a concentration adjustment tank to which the developer accumulated in said first accumulating part is conveyed, the concentration adjustment tank storing the conveyed developer and adjusting the toner concentration of the stored developer; and
a storage tank to which the developer accumulated in said second accumulating part is conveyed, the storage tank storing the conveyed developer.

2. An image formation device comprising:
a latent image support on which a latent image is formed;
a development unit having a development roller for developing said latent image formed on said latent image support by a developer which includes a toner and a carrier liquid;
a first squeeze unit having a first squeeze roller for recovering a developer by making contact with said latent image support developed by said development roller, and a first accumulating part for accumulating the developer recovered by said first squeeze roller;
a second squeeze unit having a second squeeze roller for recovering the developer by making contact with said latent image support squeezed by said first squeeze roller, and a second accumulating part for accumulating the developer recovered by said second squeeze roller;
a concentration adjustment tank to which the developer accumulated in said first accumulating part is conveyed, the concentration adjustment tank storing the conveyed developer and adjusting the toner concentration of the stored developer; and
a storage tank to which the developer accumulated in said second accumulating part is conveyed, the storage tank storing the conveyed developer.

3. The image formation device according to claim 2, wherein
said development unit is provided with a development roller cleaning member for recovering the developer by making contact with said development roller; and
said concentration adjustment tank stores the developer recovered by said development roller cleaning member.

4. The image formation device according to claim 3, further comprising:
a first duct through which the developer recovered by said cleaning member flows to said concentration adjustment tank; and
a second duct through which the developer recovered by said first squeeze roller flows into said first duct, the second duct being communicated with said first duct.

5. The image formation device according to claim 2, further comprising:
a transfer unit for transferring the image developed on said latent image support to a transfer medium by making contact with said latent image support squeezed by said second squeeze roller; and
a cleaning unit having a cleaning member for making contact with and cleaning said latent image support from which said image is transferred to said transfer member by said transfer unit, and recovering the developer; wherein
said storage tank stores the developer recovered by the cleaning member of said cleaning unit.
